(19) United States
(12) Patent Application Publication
(10) Pub. No.: US 2006/0032591 A1
(43) Pub. Date: Feb. 16, 2006

(54) Installation and method of applying a lahel to a flowerpot and flowerpot thus obtained

(76) Inventor: William Van Der Burg, Noordwijk (NL)

Correspondence Address: YOUNG & THOMPSON, 745 SOUTH 23RD STREET, 2ND FLOOR, ARLINGTON, VA, 22202, US

(21) Appl. No.: 11/201,336

(22) Filed: Aug. 11, 2005

(30) Foreign Application Priority Data
Jul. 27, 2004 (NL) 1026731

(51) Int. Cl. B65C 9/00; B65C 9/08; B65C 11/04

(52) U.S. Cl. 156/566; 156/569; 156/578

(57) ABSTRACT

Method for applying a label to a flowerpot. Before placing the label the flowerpot is provided with hot melt adhesive, after which the label, which in itself is not adhesive, is pressed against the flowerpot. The hot melt adhesive is sprayed by an adhesive applicator station onto a series of pots moving past said station. In the applied position, the label protrudes above the rim of the pot. The invention also relates to a flowerpot with label thus obtained. A particular variant is a flowerpot where the label is affixed to the flowerpot using hot melt adhesive, but part of the label protrudes beyond the flowerpot.

### FIELD OF THE INVENTION

The invention relates to a device and method for applying labels to a flower pot.

### BACKGROUND OF THE INVENTION

Such a method is generally known in the art. Labels are either inserted into the substrate material in the pot or are affixed to the actual pot by gluing.

In the first case the labels do not have to be self-adhesive, but stringent requirements are imposed on the stiffness of said label in order to make insertion into the substrate possible. In this case there is, moreover, the risk that the labels are lost during transport or shift into an undesirable position.

When applying self-adhesive labels the labels are supplied on a roll, which roll is provided with a carrier layer to which the self-adhesive labels are affixed. At the time of application, label and carrier layer are separated and the carrier layer is removed as waste and the label separated off in this way is pressed onto the flowerpot and stuck thereto. The label is prevented from becoming detached from the flowerpot in this way.

Although such a self-adhesive label is adequate, the costs are high and the waste produced with this method is undesirable. It is also not easily possible to change the printing on the label shortly before applying the label or when applying it.

WO 02/44029 discloses a label applicator machine with which adhesive is applied to a container, followed by the application of a label.

U.S. Pat. No. 4,962,871 discloses an applicator device for adhesive.

EP 0 934 844 discloses an installation for applying self-adhesive labels.

### SUMMARY OF THE INVENTION

The aim of the present invention is to provide an installation with which, on the one hand, labels can be affixed to a flowerpot in a guaranteed manner and, on the other hand, the costs per label are low, wherein it is easily possible to make changes to the label until just before the time of application.

It is a further aim of the invention to provide a method allowing connection of the labels applying labels to a flowerpot. According to a first aspect of the invention a device is provided for applying labels to a flower pot comprising a label applicator station, a conveyor for moving a series of flowerpots past said applicator station, a stock of labels and means for separating a label from the stock, and applicator means for applying a separated label to a flowerpot, wherein an adhesive applicator station with a stock of hot melt adhesive is arranged upstream in the direction of movement of said flowerpots with respect to said label applicator station, wherein said applicator station has means for positioning labels on a flowerpot, constructed such that part of said labels is arranged protruding above the rim of the flowerpots.

According to a further aspect of the invention a method is provided for applying a label to a flowerpot comprising the provision of a stock of labels, separating a label from said stock, moving a series of flowerpots, in each of which a plant has been placed, in a direction of movement past an application location and applying a separated label to a flowerpot moving past said application location, wherein upstream of said application location in the direction of movement of said flowerpots hot melt adhesive is applied to each flowerpot to be provided with labels and in that at the application location said label is applied to the flowerpot covering said hot melt adhesive, wherein said label is applied in such a way that part thereof protrudes beyond said flowerpot.

In the art it is known per se to apply labels to containers with the aid of hot melt adhesive. However, despite the fact that the need for a less expensive and more flexible method for applying labels to pot plants has already existed for a long time, there is no indication to be found in the literature for carrying this out for pot plants as well. Surprisingly, it has been found that good adhesion of the label can be obtained via the hot melt adhesive even when the pots are slightly soiled. With the present invention it is easily possible to attach labels to the pots in a guaranteed manner so they protrude above the pot to some extent.

After all, increasingly more stringent requirements are being imposed on the positioning of labels. To date many push-in labels are used that are pushed into the substrate for the plant. It has been found that it cannot be guaranteed under all circumstances that such a pushed-in label actually also remains inserted in the substrate. Moreover, the wording on the label can easily become inaccessible because of the plant.

Other methods of affixing are also found to be unsuccessful.

According to an advantageous embodiment of the invention the label is provided with an opening, the dimensions of which correspond to the rim of the pot. During application the flat label is curved to some extent because this is pressed against the outer periphery of the pot and glued. At the rim the label does not have to follow the curvature of the rim because the label is not in contact with the rim at this location because of the presence of the opening. As a result it is possible to prevent the label becoming damaged when adjacent pots bump into one another and, moreover, further localising of the label with respect to the pot rim is obtained.

Preferably the hot melt adhesive is applied to at least two locations on the flowerpot. Preferably these two locations are above one another. The hot melt adhesive used can be any type of adhesive known in the art. In certain applications a type of adhesive is preferably used by means of which it is possible to remove the label easily from the pot without leaving residues on the pot and optionally to affix it again at a later point in time.

Because the label is affixed to the pot in a guaranteed manner it is possible to realise special constructions. One such construction comprises a label that partially protrudes beyond the pot. A label that partially protrudes above a flowerpot is mentioned as an example. As a result the beneficial effect that is obtained in the case of labels that are inserted in the substrate is produced, that is to say the label is close to the plant. On the other hand, as a result of the gluing technique it is possible to ensure that the label remains in that position, even under severe transport conditions.

Such a construction is possible only with the technique described above. After all, if the label were to be self-adhesive, a sticky part would protrude beyond the pot and would rapidly become contaminated or lead to an undesired result in some other way. Labels protruding above a pot are particularly attractive for pot plants.

With the present invention it is possible to apply printing to the label or to make further changes just before the label is applied. It is also possible to take labels from different stocks, switching rapidly, and to apply different labels to pots containing different plants or with different destinations.

The present invention also relates to a flowerpot provided with a label affixed thereto, wherein said flowerpot comprises a plastic container with a plant arranged therein, wherein said label is affixed to said flowerpot using hot melt adhesive.

The invention furthermore relates to an installation for applying labels to a flowerpot, comprising a label applicator station, a conveyor for moving a series of flowerpots past said applicator station, a stock of labels and means for separating a label from the stock, and applicator means for applying a separated label to a flowerpot, wherein an adhesive applicator station with a stock of hot melt adhesive is arranged upstream in the direction of movement of said flowerpots with respect to said label applicator station.

The adhesive applicator means can comprise any construction known in the art. Preferably spray nozzles are used that are located some distance away from the flowerpots moving past them. Strips of adhesive can be applied to the flowerpot as it moves past. It has been found that in combination with the labels a particularly high speed for the application of labels can be achieved. The speed at which the labels are ultimately placed on the pots determines the speed of the system.

Furthermore, a pressing device for additionally pressing the labels firmly onto the pot can be located downstream of the station where the labels are applied. In principle, however, such a pressing station is not necessary if the hot melt adhesive is suitably chosen.

Here labels are understood to be any information carrier. Such an information carrier can bear information with regard to the plant or the care thereof as well as information on the origin, advertising information, price information and the like.

### BRIEF DESCRIPTION OF THE DRAWINGS

FIG. 1 shows, diagrammatically, a plan view of an installation for applying labels to flowerpots;

FIG. 2 shows, diagrammatically, a side view of the installation according to FIG. 1 at the adhesive applicator station;

FIG. 3 shows, diagrammatically, the installation according to FIG. 1 at the label applicator station; and

FIG. 4 shows a special embodiment of a label applied to a pot plant.

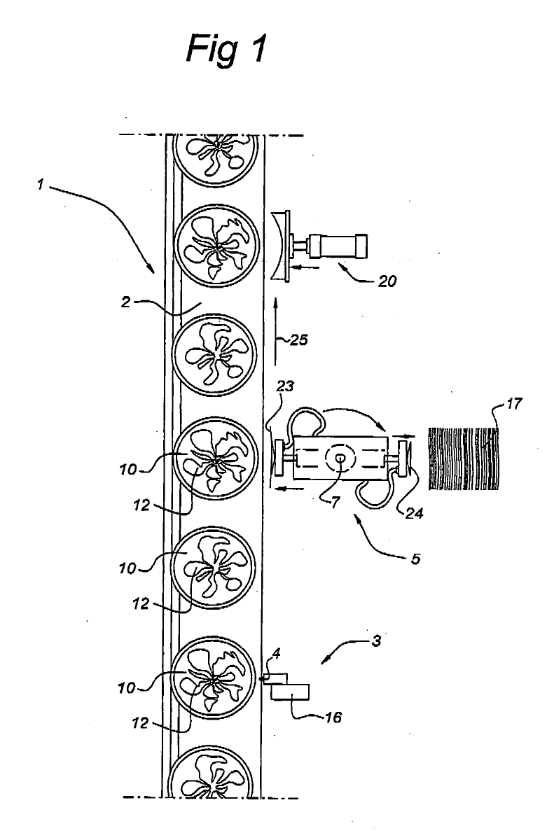

In FIG. 1 an installation for applying labels to a pot plant is indicated by 1. This installation consists of a conveyor 2 that moves in the direction of arrow 25. A large number of pot plants 10 are placed on this conveyor. The plants can be the same or also different. These pot plants 10 move in succession past an adhesive applicator device or adhesive applicator station 3. They then move past a label applicator device or label applicator station 5. There is optionally a pressing device 20 downstream of this. This can comprise a head of deformable material, such as foam material.

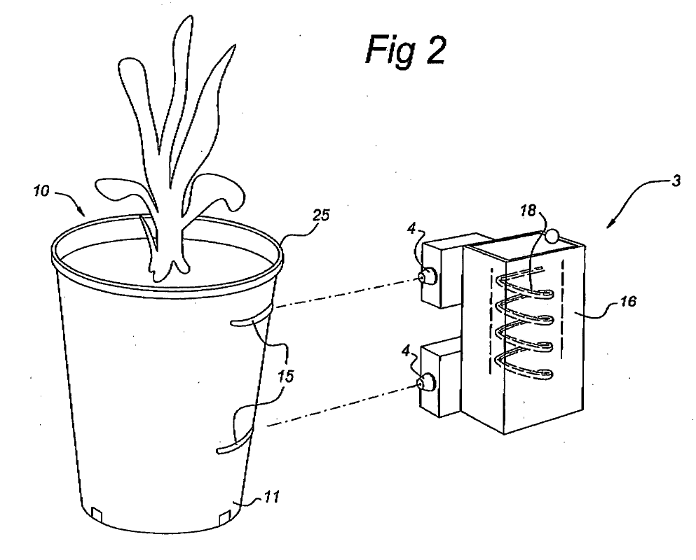

It can be seen from FIG. 2 that the adhesive applicator device consists of two dispensing nozzles 4, in which a stop valve is incorporated, located vertically some distance apart. Hot melt adhesive comes from a store 16 and is kept at the correct temperature by means of a heating coil 18. By controlling the stop valve in nozzle 4 a spot, strip or “broken line” can be applied to the pot plant 10.

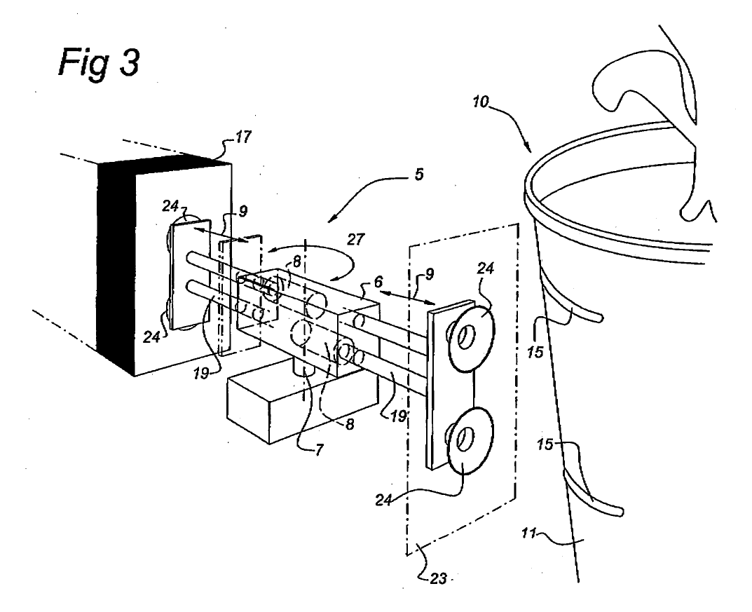

The pot plant concerned then moves in the direction of arrow 25 to the label applicator station. The various features are illustrated further in FIG. 3. It can be seen from this figure that such a station consists of a stock 17 of labels as well as an arm 6, with two arm parts 19, which can rotate about a shaft 7. At each arm part 19 there is always a cylinder 8 that can be extended in the direction of arrow 9 and can also be actively shortened. There is a suction cup 24 at the end of arm part 19. In a manner not shown in more detail, vacuum can be applied to the suction cup 24 and cylinder 8 can be operated (for example using compressed air).

With shaft 7, the label applicator device 5 makes a rotary movement in the direction of arrow 27 (FIG. 3). This can be a continuous rotary movement or a reciprocating movement. During rotation the suction cups 24 are preferably as close as possible to the shaft 7, that is to say the cylinders are not extended. When the stock 17 is reached, or pot plant 10 has been correctly positioned, the cylinder 8 is activated and moves in the direction of arrow 9.

On retraction and with the application of vacuum, a label will be taken from store 17. On the same retraction from the flowerpot and on removing the vacuum, the label will remain on the hot melt adhesive.

In order to be certain that the labels are firmly affixed to the pot concerned, there is a pressing device 20 that presses the label onto the pot with a rapid pressing or striking movement.

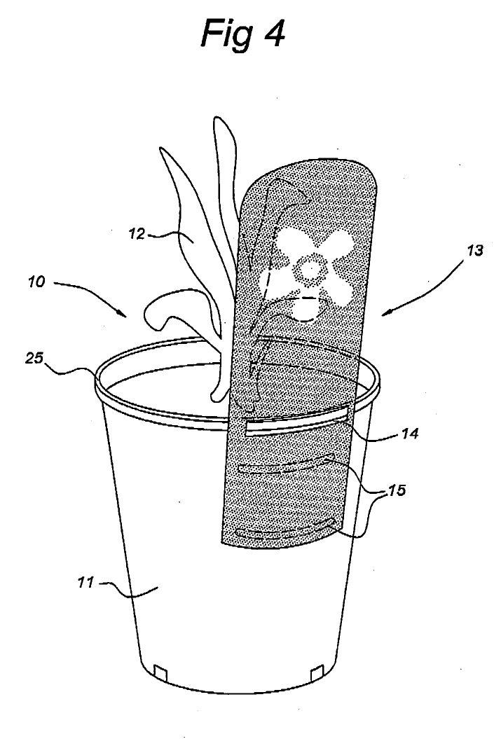

A special embodiment of the label, which is indicated by 13, is shown in FIG. 4. This label has a top part and a bottom part, the bottom part being glued by means of hot melt adhesive 15 to flowerpot 11 of pot plant 10 in the manner described above. Above the bottom part there is an opening 14, above which the top part of the label extends. This opening is precisely at the position of the rim 25 of the pot. As a result the label is, on the one hand, supported by the rim of the pot and, on the other hand, damage to the label as a result of rims of adjacent pots bumping into one another is prevented. The plant is indicated by 12. In this way part of the label 13 is positioned close to the plant 12, which can be desirable under certain circumstances, without their being the risk of the label coming out of the substrate during transport or rough handling. Furthermore, label 13 is the outermost part of the pot plant.

Although the invention has been described above with reference to a preferred embodiment, variants that fall within the scope of the appended claims will be immediately apparent to those skilled in the art.

1. Installation for applying labels to a flowerpot, comprising a label applicator station, a conveyor for moving a series of flowerpots past said applicator station, a stock of labels and means for separating a label from the stock, and applicator means for applying a separated label to a flowerpot, wherein an adhesive applicator station with a stock of hot melt adhesive is arranged upstream in the direction of movement of said flowerpots with respect to said label applicator station, wherein said applicator station has means for positioning labels on a flowerpot, constructed such that part of said labels is arranged protruding above the rim of the flowerpots.

2. Installation according to claim 1, wherein said adhesive applicator station comprises nozzles for adhesive.

3. Installation according to claim 1, wherein said adhesive applicator station has heating means for adhesive.

4. Installation according to claim 2, wherein said means for separating labels from a stock comprise a rotary and extendable arm part provided with a suction cap at the end, which arm part can be moved between a position by said stock and a position in front of said flowerpot.

5. Installation according to claim 4, comprising two arm parts joined to one another and located in the extension of one another.

6. Method for applying a label to a flowerpot, comprising the provision of a stock of labels, separating a label from said stock, moving a series of flowerpots, in each of which a plant has been placed, in a direction of movement past an application location and
applying
a separated label to a flowerpot moving past said application location, wherein upstream of said application location in the direction of movement of said flowerpots hot melt adhesive is applied to each flowerpot to be provided with labels and in that at the application location said label is applied to the flowerpot covering said hot melt adhesive, wherein
said
label is applied in such a way that part thereof protrudes beyond said flowerpot.

7. Method according to claim 6, wherein hot melt adhesive is applied to two locations on said flowerpot.

8. Method according to claim 6, wherein the pot is provided with a rim and said label
is
provided with an opening, wherein said label is applied to said pot in such a way that said rim of said pot extends through said cut-out.

9. Flowerpot provided with a label affixed thereto, wherein said flowerpot comprises a plastic container with a plant arranged therein, said label being affixed to said flowerpot using hot melt adhesive and said label protrudes beyond said flowerpot.

10. Flowerpot according to claim 9, wherein said label is provided with a cut-out and said pot is provided with a rim, wherein said opening is arranged at the location of said rim.
